(19) United States
(12) Patent Application Publication
(10) Pub. No.: US 2014/0258524 A1
(43) Pub. Date: Sep. 11, 2014

(54) Detection of Load Balancing Across Network Paths in a Communication Network

(71) Applicants: Tomas Thyni, Jarfalla (SE); Mats Forsman, Ronninge (SE); Annikki Welin, Solna (SE)

(72) Inventors: Tomas Thyni, Jarfalla (SE); Mats Forsman, Ronninge (SE); Annikki Welin, Solna (SE)

(73) Assignee: Telefonaktiebolaget L M Ericsson (publ), Stockholm (SE)

(21) Appl. No.: 14/351,219

(22) PCT Filed: Oct. 13, 2011
(86) PCT No.: PCT/SE2011/051224

§ 371 Date: Apr. 11, 2014

(51) Int. Cl. H04L 12/26

(52) U.S. Cl. CPC H04L 43/50
USPC 709/224

(57) ABSTRACT

The present disclosure relates to methods, a system and an apparatus for detection of load balancing in a packet-switched communication network (10). According to an embodiment a plurality of test sessions(22, 23, 24, 25) are initiated, which differ with respect to at least one associated parameter value for a source address, a destination address, a source port, a destination port, or a protocol. Load detection in the packet-switched communication network (10) can be detected based on differences between measurement results (28) of different test sessions (22, 23, 24, 25) of the plurality of test sessions. Situations where one network path is measured, while application traffic (21) takes another unmeasured network path can be avoided by setting-up multiple simultaneous test sessions (22, 23, 24, 25) with differing parameter values such that the test sessions are routed differently by any hash algorithms(19a, 19b, 19c, 19d) used for load balancing across network paths.

### TECHNICAL FIELD

The embodiments described herein relate to active performance monitoring in a communication network and in particular to detection of whether load balancing is applied in the communication network.

### BACKGROUND

Methods and tools for active performance monitoring are starting to become common in packet switched communication networks, such as the Internet, to monitor network Service Level Agreements (SLAs) as well as transport characteristics for applications between end nodes. Active performance monitoring, also referred to as active probing, involves injecting test packets into the network, and then analyzing the observed effects of e.g. cross traffic, traffic load and network path on the test packets. Accordingly a test session may be set-up which generally comprises a plurality of test packets transmitted at intervals from a sending end-node to a receiving end-node. Different types of measurements may be of interest such as available bandwidth, delay and delay variation. In case round-trip measurements are to be performed, the receiving end-node may return the test packets to the sending end-node. The sending end-node may also be referred to as a session sender and the receiving end-node may be referred to as a session receiver or session reflector in the case the receiving end-node reflects the test packets back to the sending end-node. The test session may be set-up such that the test packets are transmitted individually or e.g. in so-called trains comprising a plurality of test-packets. “Probing session” and “probing packet” are terms that sometimes are used synonymously with the terms “test session” and “test packet” respectively.

Several different measurement methods and tools have been developed throughout the years. One-way Active Measurement Protocol (OWAMP) is a protocol which has been specified to measure unidirectional characteristics such as one-way delay and one-way loss in IP networks. OWAMP is described in RFC 4656 published by the Internet Engineering Task Force (IETF) in September 2006. Two-way Active Measurement Protocol (TWAMP) is a based on the OWAMP but adds two-way or round-trip measurement capabilities. TWAMP is described in RFC 5357 published by the IETF in October 2008. Bandwidth Available in Real-Time (BART) is a method which applies Kalman filtering for estimating the available bandwidth of a network path. BART is e.g. disclosed in U.S. Pat. No. 7,778,179.

One potential problem or difficulty in case of active performance monitoring is load balancing. None of the measurement methods and tools exemplified above is adapted to cope with load balancing in the network to be monitored, which may give rise to useless or inapplicable measurements.

Load balancing may be used when there are multiple network paths between two nodes in the network. Using load balancing, the multiple network paths may be used simultaneously and traffic between the two nodes may be divided between the multiple network paths to e.g. avoid congestion on one or several of the network paths.

Link Aggregation Groups (LAG) and Equal Cost Multi-Path (ECMP) routing are examples of load balancing techniques. LAG and ECMP provide for session load balancing and do not consider length of the actual network paths nor load. Therefore the same session will always take the same path. However, currently there is no way to detect or steer which path the traffic takes if load balancing such as LAG or ECMP is used. Furthermore, since the measurement methods such as OWAMP and TWAMP is not able to detect load balancing in the network, it is possible that test packets of a test session will be routed or switched on one of the load balanced network paths while the traffic of a traffic session, which the test session tries to measure, is routed on another network path. Thus it is possible for a performance monitoring test session to indicate very good network characteristics at the same time as a session for an application is experiencing very bad network characteristics. This “strange” behaviour is especially disturbing when a service is leased from a network provider and the network provider is doing load balancing in a network part not seen by the customer leasing the service, like in leased mobile backhaul or Ethernet services that are common today.

Accordingly it would be beneficial to be able to detect whether load balancing is used in a network and to have active probing monitoring methods and tools which are adapted to cope with load balancing.

### SUMMARY

It is an object to provide a method and arrangements which allow for detection of load balancing in a packet-switched communication network.

The above stated object is achieved by means of methods, a system and an apparatus according to the independent claims.

A first exemplary embodiment provides a method for detecting load balancing across network paths between a first node and a second node in a packet-switched communication network. The method comprises a step of initiating a plurality of test sessions. Each of the test sessions comprises at least one test packet transmitted over the packet-switched communication network between the first node and the second node. In addition each of the test sessions is associated with a set of parameters. The set of parameters comprises at least one of a source address, a destination address, a source port, a destination port, and a protocol. The plurality of test sessions are initiated such that a value of at least one parameter of the source address, the destination address, the source port, the destination port, and the protocol differs between each of the test sessions. The method further comprises a step of detecting load balancing across network paths between the first node and the second node based on differences between measurement results of different test sessions of the plurality of test sessions.

A second exemplary embodiment provides a system for detecting load balancing across network paths between a first node and a second node in a packet-switched communication network. The system comprises control circuitry configured to initiate a plurality of test sessions. Each of the test sessions comprises at least one test packet transmitted over the packet-switched communication network between the first node and the second node. In addition each of the test sessions are associated with a set of parameters. The set of parameters comprises at least one of a source address, a destination address, a source port, a destination port, and a protocol. The control circuitry is configured to initiate the plurality of test sessions such that a value of at least one parameter of the source address, the destination address, the source port, the destination port, and the protocol differs between each of the test sessions. The system further comprises processing circuitry configured to detect load balancing across network paths between the first node and the second node based on differences between measurement results of different test sessions of the plurality of test sessions.

A third exemplary embodiment provides an apparatus for detecting load balancing across network paths between a first node and a second node in a packet-switched communication network. The apparatus comprises processing circuitry configured to process measurement results from a plurality of test sessions. Each of the test sessions comprises at least one test packet transmitted over the packet-switched communication network between the first node and the second node. In addition each of the test sessions is associated with a set of parameters. The set of parameters comprises at least one of a source address, a destination address, a source port, a destination port, and a protocol. A value of at least one parameter of the source address, the destination address, the source port, the destination port, and the protocol differs between each of the test sessions. The processing circuitry is further configured to detect load balancing across network paths between the first node and the second node based on differences between the measurement results of different test sessions of the plurality of test sessions.

A fourth exemplary embodiment provides a method in an apparatus for detecting load balancing across network paths between a first node and a second node in a packet-switched communication network. The method comprises a step of processing measurement results from a plurality of test sessions. Each of the test sessions comprises at least one test packet transmitted over the packet-switched communication network between the first node and the second node. Furthermore, each of the test sessions is associated with a set of parameters. The set of parameters comprises at least one of a source address, a destination address, a source port, a destination port, and a protocol. A value of at least one parameter of the source address, the destination address, the source port, the destination port, and the protocol differs between each of the test sessions. The method also comprises a step of detecting load balancing across network paths between the first node and the second node based on differences between the measurement results of different test sessions of the plurality of test sessions.

An advantage of certain embodiments described herein is that load balancing in a packet-switched communication network may be detected.

Another advantage of some embodiments described herein is that the applicability of network measurements may be increased since it is possible to obtain measurements for the same network path that is used by application traffic. Situations where one network path is measured, while the application traffic takes another unmeasured network path can be avoided.

A further advantage of some embodiments of this disclosure is that they can be easily combined with functions and features of different existing tools for active performance monitoring, such as e.g. OWAMP, TWAMP and BART.

Further advantages and features of embodiments of the present invention will become apparent when reading the following detailed description in conjunction with the drawings.

### BRIEF DESCRIPTION OF THE DRAWINGS

FIG. 1 is a schematic block diagram of a communication network which applies load balancing.

FIG. 2 is a schematic block diagram of the communication network of FIG. 1 with an embodiment of this disclosure implemented.

FIG. 3 is a flow diagram illustrating an embodiment of a method for detection of load balancing in a communication network.

FIG. 4 is a schematic diagram illustrating an embodiment according to which test packets of a plurality of test sessions are transmitted at intervals in bursts.

FIG. 5 is a schematic flow diagram illustrating an embodiment according to which a relative order between transmission times of test packets of different test sessions varies between different bursts.

FIG. 6 is a schematic block diagram illustrating an embodiment of a network in which measurement results of test sessions are processed in a node separate from the nodes which transmit or receive the test packets.

FIG. 7 is a flow diagram illustrating a method in an apparatus for detecting load balancing in a communication network.

### DETAILED DESCRIPTION

The present invention will now be described more fully hereinafter with reference to the accompanying drawings, in which different exemplary embodiments are shown. These exemplary embodiments are provided so that this disclosure will be thorough and complete and not for purposes of limitation.

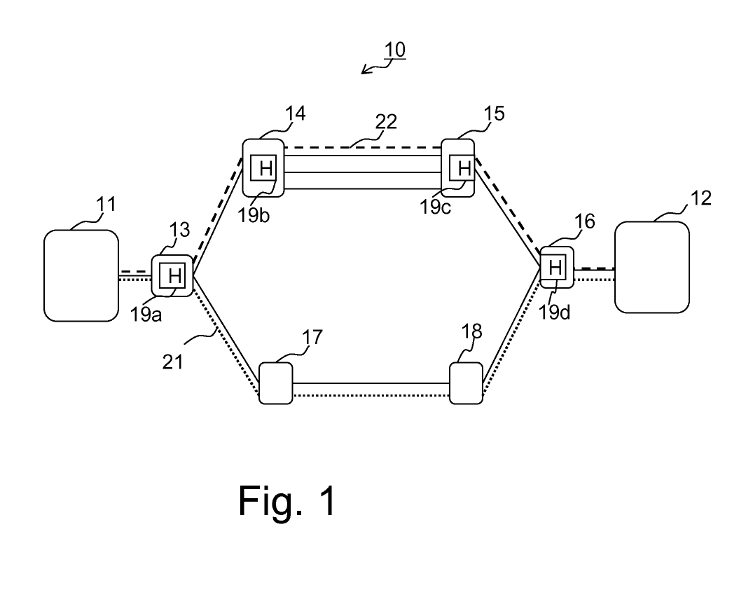

According to some of the embodiments to be described in further detail below multiple active performance monitoring test sessions are used in parallel to detect “hidden” load balancing in a packet-switched communication network such as illustrated in FIG. 1. The packet-switched communication network may be a switched or a routed network.

FIG. 1 is a schematic block diagram of an exemplary packet-switched communication network 10. Assume that it is of interest to measure network characteristics between a first node 11 and a second node 12. It is apparent from FIG. 1 that traffic between the first node 11 and the second node 12 may take different network paths. Packets arriving in an intermediate node 13 from the first node 11 may be routed either to an intermediate node 14 or to an intermediate node 17 on the way towards the second node 12. Correspondingly, packets arriving in an intermediate node 16 from the second node 12 may be routed either to an intermediate node 15 or to an intermediate node 18 on the way towards the first node 11. Furthermore, as illustrated in FIG. 1 there are three different links available between the intermediate node 14 and the intermediate node 15, which further increases the number of possible network paths between the first node 11 and the second node 12. The intermediate nodes 13, 14, 15, 16, 17 and 18 may e.g. be routers or switches. The first node 11 may e.g. be a radio base station (RBS) or evolved NodeB (eNB) and the second node 12 may e.g. be a radio network controller (RNC), Serving Gateway or public data network (PDN) gateway in a radio network scenario, or other types of nodes between which it is of interest to measure network characteristics in other types of scenarios, such as a host and a server, or Customer Located Equipment/Customer Premise Equipment (CLE/CPE) and a Broadband Network Gateway (BNG).

When several network paths between the same two nodes are known by the network 10, load balancing may be used to share traffic among the network paths. According to load balancing techniques such as ECMP or LAG, the different network paths are considered as equally good and it is generally attempted to share traffic equally between the network paths using session hashing to avoid out-of-order packet delivery. LAG and ECMP is typically implemented such that, when there are several equally good network paths to choose from, a hash algorithm or function will check certain headers of the packets that have same values throughout a packet session flow and use a resulting output hash value to select a particular network path. If the hash function is chosen so that the output value has a uniform statistical distribution, it will generate a hash output value and share the traffic equally between the network paths provided that the number of different sessions is high. Many load balancing implementations use a 5-tuple consisting of destination address, source address, protocol, destination port and source port as input to the hash function to maximize the probability of evenly sharing the traffic over the network paths.

FIG. 1 schematically illustrates that intermediate nodes 13, 14, 15 and 16 applies hash algorithms 19a, 19b, 19c and 19d respectively to implement load balancing in the network 10.

As described above in the background section, when active performance monitoring using conventional tools is to be performed in a network with load balanced paths, there is a risk that no measurements are performed on the network path which carries the real data traffic. Such a scenario is illustrated in FIG. 1. Data packets of an application session 21, i.e. real data traffic (illustrated as dotted lines) are routed between the first node 11 and the second node 12 via the intermediate nodes 13, 17, 18 and 16. Test packets of a test session 22 (illustrated as dashed lines) are instead routed between the first node 11 and the second node 12 via the intermediate nodes 13, 14, 15 and 16. Accordingly the test session 22 takes a different path than the application session 21, which may lead to situations where the measurement results of the test session 22 e.g. indicates very good network characteristics while the application session in fact experiences very poor network characteristics or vice versa. Note that even if, the test session 22 and the application session 21 were routed via the same intermediate nodes it is not certain that the different sessions actually take the same network path. This is because there may be multiple alternative links between two adjacent nodes as illustrated in FIG. 1 between the intermediate nodes 14 and 15.

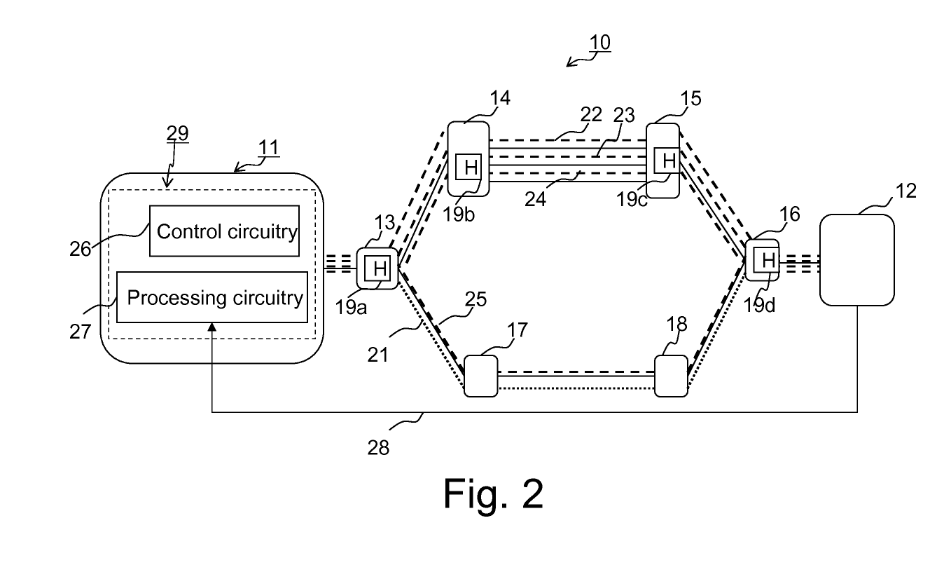

FIG. 2 is a schematic block diagram of the network 10 with an embodiment for avoiding situations as the one illustrated in FIG. 1 implemented. According to the illustrated embodiment, a plurality of test sessions 22, 23, 24, 25 are generated in parallel with different characteristics to produce different hashing of the different test sessions 22, 23, 24 and 25 by the hash algorithms 19a, 19b, 19c and 19d. The different test sessions 22, 23, 24 and 25 will thus take different network paths between the first node 11 and the second node 12. In FIG. 2 it is illustrated that the test session 25 takes the same network path as the application session 21. Accordingly measurement results are obtained for the network path which carries the application session 21.

As mentioned above hash algorithms implementing load balancing generally operate based on parameters such as source and destination port, source and destination address and protocol. Thus by initiating many different test sessions with differing parameter values for one or several of the parameter types that the hash algorithms are expected to use for load balancing, it can be expected that at least some of the different sessions will take different network paths if load balancing is applied in the network. The plurality of test sessions 22, 23, 24 and 25 may thus be initiated with e.g. different source and/or destinations ports, or with different source and/or destination addresses, provided that the first node 11 and/or second node 12 can be associated with multiple addresses, typically Internet Protocol (IP) addresses. Since there are cases where packets according to different protocols are routed differently in the network 10 due to policy routing, the test sessions 22, 23, 24 and 25 may also be initiated with different protocol types. Some test sessions may e.g. use test packets according to User Datagram Protocol (UDP), while other test sessions are based on Transmission Control Protocol (TCP) packets or Stream Control Transmission Protocol (SCTP) packets. TWAMP and OWAMP are based on UDP packets. Accordingly if TWAMP and OWAMP were extended to support e.g. TCP measurements as well, this feature of differing protocol types between test sessions could be implemented using TWAMP or OWAMP sessions.

The likelihood of detecting and obtaining measurements for all of the available network paths between two nodes increases with the number of test sessions performed in parallel and with a higher variation in the values of the parameters upon which load balancing is expected to be based. Note that it is here assumed that it is not known whether load balancing is used in the network 10 and it is further assumed that it is not known how any load balancing, if present, would operate.

In the embodiment illustrated in FIG. 2, a control circuitry 26 comprised in the first network node 11 initiates the plurality of test sessions 22, 23, 24 and 25 in parallel to support automatic detection of load balancing and multiple network paths between the first node 11 and the second node 12. It is in this example assumed that the first node 11 is the sending node. FIG. 2 also illustrates that the first node 11 comprises processing circuitry 27 for processing measurement results 28 of the plurality of test sessions 22, 23, 24, 25. By analyzing the measurement results 28, the processing circuitry 27 can detect load balancing in the network 10. Based on differences between measurement results of different test sessions it can be detected if different test sessions have taken different network paths. Generally each test session comprises a plurality of test packets transmitted at intervals. By analyzing measurement results over time systematic differences in measurements results of different test sessions may be detected. These differences may then be interpreted as an indication that two different test sessions have taken different network paths or the same network path. Trains of test packets of different test sessions may e.g. be time-stamped to measure the delay between the first node 11 as sending node and the second node 12 as receiving node. The times associated with packets of the different test sessions are then compared to detect if the different test sessions have taken different paths. According to some exemplary embodiments, if the difference in measurements results of two test sessions is large, above a first threshold value, it is detected that the two sessions have traversed the network 10 over different network paths. Correspondingly, if the difference in measurement results of the two sessions is small, below a second threshold value, it is detected that the two test sessions have traversed the network 10 over the same network path. Suitable values of the first and second threshold value depends on several factors, such as type and size of the network and length of the network paths.

From the above example, it can be seen that the plurality of test sessions typically would lead to a learning process, where measurement results are grouped and conclusions regarding network characteristics, including load balancing, are drawn based on detected systematic differences between different test sessions. It should be noted that it is possible that each test session of the plurality of test sessions comprises a single test packet or merely a few test packets. However, a higher number of test packets per test session increases the reliability in the conclusions drawn from the measurements results of the test sessions.

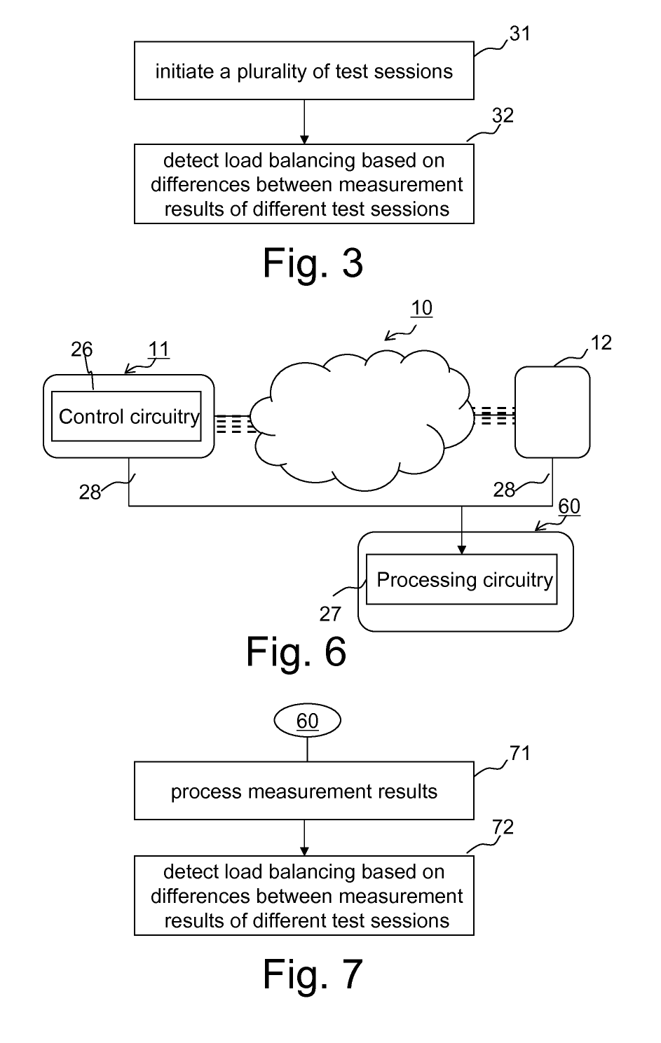

FIG. 3 is a schematic flow diagram illustrating a flow diagram of a method for detecting load balancing across network paths between two nodes in packet-switched network, such as between the first node 11 and the second node 12 of the network 10 illustrated in FIG. 2. The method comprises a step 31 of initiating a plurality of test sessions. Each test session of the plurality of test sessions comprises at least one test packet transmitted over the packet-switched communication network between the first node 11 and the second node 12, and each test session of the plurality of test sessions is associated with a set of parameters. The set of parameters comprises at least one of a source address, a destination address, a source port, a destination port, and a protocol. The plurality of test sessions are initiated such that values of at least one parameter of the source address, the destination address, the source port, the destination port, and the protocol differ between each of the test sessions. The method further comprises a step 32 of detecting load balancing across network paths between the first node 11 and the second node 12 based on differences between measurement results of different test sessions of the plurality of test sessions.

When referring herein to a plurality of parallel or simultaneous test sessions this means that the test sessions are active at the same time. Typically at least one test packet from each of the plurality of test sessions is transmitted from the sending node substantially simultaneously. The sending node is typically not capable of transmitting packets of all the test sessions at exactly the same time, but the test packets could be transmitted adjacent to each other. The test packets are also time-stamped so a difference in actual transmission times of different test packets can be monitored.

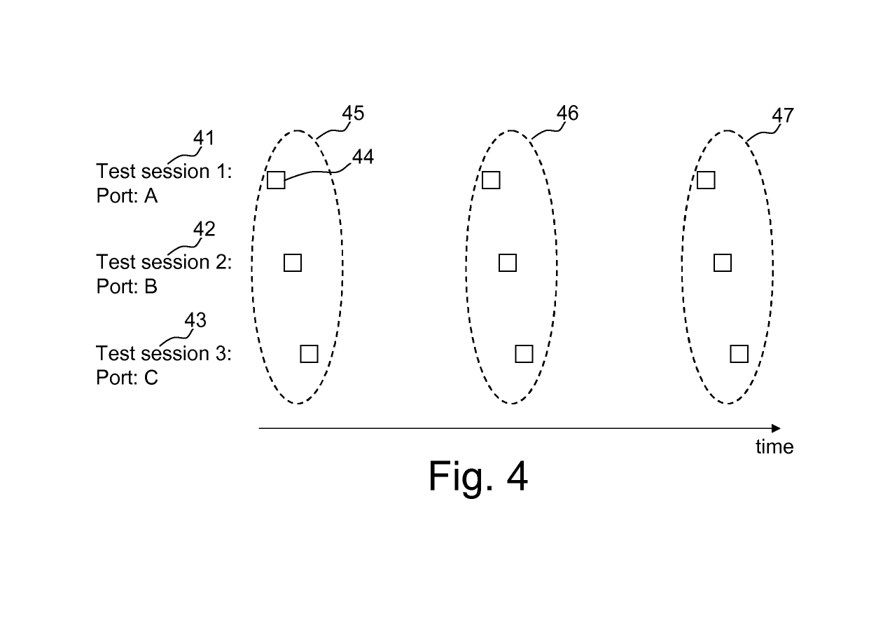

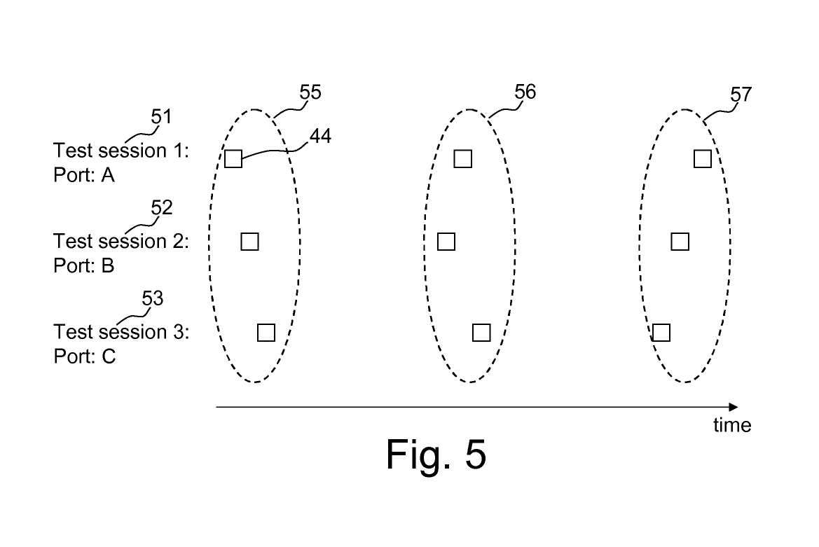

According to some embodiments the test sessions comprises a plurality of test packets transmitted from the sending node at intervals, as mentioned above. FIG. 4 illustrates a scenario with three test sessions 41, 42 and 43. The test sessions are associated with different source ports A, B and C respectively to produce different routing of the test sessions if load balancing is used in the network to be measured. The test sessions 41, 42 and 43 comprises a plurality of test packets 44 transmitted at intervals in bursts. In FIG. 4, three consecutive bursts 45, 46 and 47 are illustrated. FIG. 4 schematically illustrates transmission times from the sending node of the test packets of the different test sessions 41, 42 and 43. The time between transmission times of packets within a burst is considerably smaller than the time between transmission times of packets of different bursts as illustrated in FIG. 4. In the exemplary embodiment illustrated in FIG. 4 a packet of the test session 41 is transmitted first in each burst 45, 46, 47, followed by a packet from the test session 42 and last a test packet from the test session 43. To avoid that the measurement results of the different test sessions 41, 42, 43 depend on the order at which the test packets are transmitted in the bursts 45, 46, 47 the relative order between transmission times of the test packets of different test sessions may be varied between the different bursts e.g. as illustrated in FIG. 5.

FIG. 5 illustrates a scenario similar to the one illustrated in FIG. 4, with three parallel test sessions 51, 52 and 53 comprising test packets 44 transmitted in bursts 55, 56 and 57 from the sending node. It can be seen from FIG. 5 that a relative order between transmission times of the test packets of different test sessions differs between the different bursts 55, 56 and 57. It can e.g. be seen that, in the burst 55 a test packet from the test session 51 is transmitted first, but in the burst 56 a test packet from the test session 52 is transmitted first. Thus the measurement results of the different test sessions, when seen over time, can be made independent on the relative order of transmission times within a burst.

According to the exemplary embodiment illustrated in FIG. 2, the processing circuitry 27 configured to detect load balancing across network paths is comprised in the first node 11, which is the sending node. If round-trip measurements are of interest the test packets will be returned from the second node 12, i.e. the receiving node, to the sending node 11 and the processing circuitry will thus be able to obtain the measurement results 28 of the plurality of test sessions 22, 23, 24, 25. If one-way measurements are of interest the receiving node 12 would need to transmit the measurement results 28 to the processing circuitry 27 in the sending node. The processing circuitry 27 may however be located in many different locations, such as in the receiving node, in a central operation and maintenance (O&M) node or at some other location. Similarly the control circuitry 26 which is configured to initiate the plurality of test sessions for load balance detection can be located at different locations. In FIG. 2 it is illustrated that the control circuitry 26 and the processing circuitry 27 are co-located in a unit 29. FIG. 6 illustrates an exemplary embodiment according to which the control circuitry 26 and the processing circuitry 27 are comprised in different nodes. The control circuitry 26 is in FIG. 6 still comprised in the sending node 11, while the processing circuitry 27 is comprised in an apparatus 60 separate from the sending node 11 and the receiving node 12. The measurement results 28 of the plurality of test sessions therefore need to be communicated from the sending and/or receiving nodes 11, 12 to the apparatus 60.

FIG. 7 is a flow diagram illustrating an embodiment of a method in the apparatus 60 for detecting load balancing across network paths between the first node 11 and the second node 12. The method comprises a step 71 of processing measurement results from a plurality of test sessions and a step 72 of detecting load balancing across network paths between the first node 11 and the second node 12 based on differences between the measurement results 28 of different test sessions of the plurality of test sessions.

The control circuitry 26 and the processing circuitry 27 mentioned above may be embodied in the form of one or more programmable processors programmed to perform the steps according to the methods described herein. However, any data processing circuitry or combination of different types of processing circuits that is capable of performing the mentioned steps could be used. Several of the embodiments described herein may thus be implemented by means providing appropriate network elements with new software, which may be comprised in one or several computer program products embodied in the form of a volatile or non-volatile memory, e.g. a RAM, an EEPROM, a flash memory or a disc drive.

From the above description it is apparent that an advantage of certain embodiments described herein is that load balancing in a packet-switched communication network may be detected.

Another advantage of some embodiments described herein is that the applicability of network measurements may be increased since it is possible to obtain measurements for the same network path that is used by application traffic. Situations where one network path is measured, while the application traffic takes another unmeasured network path can be avoided. By generating multiple parallel test sessions which uses different parameters, such as destination/source port, destination/source address and/or protocol type the different test sessions may be forced to take different network paths. Thus load balancing may be detected by comparing measurement results of the plurality of test sessions and measurement results may be obtained for different network paths.

A further advantage of some embodiments of this disclosure is that they can be easily combined with functions and features of different existing tools for active performance monitoring, such as e.g. OWAMP, TWAMP and BART. The plurality of test sessions that are initiated for detection of load balancing may thus be OWAMP sessions, TWAMP sessions BART sessions or some other type of test sessions.

For detection of load balancing based on the measurement results of the plurality of test sessions, different types of analysis methods may be used to analyze the measurement results. Kalman filtering, CUSUM (Cumulative sum) or a combination of both techniques may e.g. be used in a learning and detection process to detect systematic differences in measurement results between different test sessions.

In the drawings and specification, there have been disclosed typical embodiments and, although specific terms are employed, they are used in a generic and descriptive sense only and not for purposes of limitation, the scope of the invention being set forth in the following claims.

1. A method for detecting load balancing across network paths between a first node and a second node in a packet-switched communication network, the method comprising:
initiating a plurality of test sessions, each test session of the plurality of test sessions comprising at least one test packet transmitted over the packet-switched communication network between the first node and the second node, and each test session of the plurality of test sessions being associated with a set of parameters, the set of parameters comprising at least one of a source address, a destination address, a source port, a destination port, and a protocol, wherein the plurality of test sessions are initiated such that values of at least one parameter of the source address, the destination address, the source port, the destination port, and the protocol differ between each of the test sessions; and
detecting load balancing across network paths between the first node and the second node based on differences between measurement results of different test sessions of the plurality of test sessions.

2. The method according to claim 1, wherein it is detected that test packets of two different test sessions of the plurality of test sessions have traversed the packet-switched network over different network paths if a difference in measurement results of the two different test sessions is above a first threshold value.

3. The method according to claim 1, wherein it is detected that test packets of two different test sessions of the plurality of test sessions have traversed the packet-switched network over the same network path if a difference in measurement results of the two different test sessions is below a second threshold value.

4. The method according to claim 1, wherein said measurement results includes delay and/or delay variation associated with the test packets of the plurality of test sessions.

5. The method according to claim 1, wherein at least one test packet of each test session of the plurality of test sessions are transmitted from the first node or the second node substantially simultaneously.

6. The method according to claim 1, wherein each test session of the plurality of test sessions comprises a plurality of test packets transmitted at intervals from the first node or the second node.

7. The method according to claim 6, wherein the test packets are transmitted from the first node or the second node in bursts such that a relative order between transmission times of the test packets of different test sessions differs between the different bursts.

8. The method according to claim 6, wherein said detecting of load balancing across network paths is performed based on systematic differences in measurement results for test packets of different test sessions.

9. The method according to claim 1, wherein the test sessions are Two-way Active Measurement Protocol, TWAMP, sessions, One-way Active Measurement Protocol, OWAMP, sessions or Bandwidth Available in Real-Time, BART, sessions.

10. A system for detecting load balancing across network paths between a first node and a second node in a packet-switched communication network, the system comprising:
control circuitry configured to initiate a plurality of test sessions, each test session of the plurality of test sessions comprising at least one test packet transmitted over the packet-switched communication network between the first node and the second node, and each test session of the plurality of test sessions being associated with a set of parameters, the set of parameters comprising at least one of a source address, a destination address, a source port, a destination port, and a protocol,
wherein the control circuitry is configured to initiate the plurality of test sessions such that values of at least one parameter of the source address, the destination address, the source port, the destination port, and the protocol differ between each of the test sessions and wherein the system further comprises:
processing circuitry configured to detect load balancing across network paths between the first node and the second node based on differences between measurement results of different test sessions of the plurality of test sessions.

11. The system according to claim 10, wherein the processing circuitry is configured to detect that test packets of two different test sessions of the plurality of test sessions have traversed the packet-switched network (10) over different network paths if a difference in measurement results of the two different test sessions is above a first threshold value.

12. The system according to claim 10, wherein the processing circuitry is configured to detect that test packets of two different test sessions of the plurality of test sessions have traversed the packet-switched network over the same network path if a difference in measurement results of the two different test sessions is below a second threshold value.

13. The system according to claim 10, wherein said measurement results includes delay and/or delay variation associated with the test packets of the plurality of test sessions.

14. The system according to claim 10, wherein the control circuitry is configured to control that at least one test packet (44) of each test session of the plurality of test sessions are transmitted from the first node or the second node substantially simultaneously.

15. The system according to claim 10, wherein the control circuitry is configured to initiate the plurality of test sessions such that each test session comprises a plurality of test packets transmitted at intervals from the first node or the second node.

16. The system according to claim 15, wherein the control circuitry is configured to control that the test packets are transmitted from the first node or the second node in bursts such that a relative order between transmission times of the test packets of different test sessions differs between the different bursts.

17. The system according to claim 15, wherein the processing circuitry is configured to detect load balancing across the network paths based on systematic differences in measurement results for test packets of different test sessions.

18. The system according to claim 10, wherein the test sessions are Two-way Active Measurement Protocol, TWAMP, sessions, One-way Active Measurement Protocol, OWAMP, sessions or Bandwidth Available in Real-Time, BART, sessions.

19. The system according to claim 10, wherein the processing circuitry is comprised in the first node or in the second node and the control circuitry is comprised in the first node or in the second node.

20. The system according to claim 10, wherein the processing circuitry and the control circuitry are comprised in different nodes.

21. An apparatus for detecting load balancing across network paths between a first node and a second node in a packet-switched communication network, the apparatus comprising:
processing circuitry configured to:
process measurement results from a plurality of test sessions, wherein each test session of the plurality of test sessions comprises at least one test packet transmitted over the packet-switched communication network between the first node and the second node, wherein each test session of the plurality of test sessions is associated with a set of parameters, the set of parameters comprising at least one of a source address, a destination address, a source port, a destination port, and a protocol, and wherein values of at least one parameter of the source address, the destination address, the source port, the destination port, and the protocol differ between each of the test sessions; and-to
detect load balancing across network paths between the first node and the second node based on differences between the measurement results of different test sessions of the plurality of test sessions.

22. A method in an apparatus for detecting load balancing across network paths between a first node and a second node in a packet-switched communication network, the method comprising:
processing measurement results from a plurality of test sessions, wherein each test session of the plurality of test sessions comprises at least one test packet transmitted over the packet-switched communication network (10) between the first node and the second node, wherein each test session of the plurality of test sessions is associated with a set of parameters, the set of parameters comprising at least one of a source address, a destination address, a source port, a destination port, and a protocol, and wherein values of at least one parameter of the source address, the destination address, the source port, the destination port, and the protocol differ between each of the test sessions; and
detecting load balancing across network paths between the first node and the second node based on differences between the measurement results of different test sessions of the plurality of test sessions.
